(19) United States
(12) Patent Application Publication
(10) Pub. No.: US 2013/0105470 A1
(43) Pub. Date: May 2, 2013

(54) METHOD AND SYSTEM FOR COOKING AND SEARING A FOOD PRODUCT IN A SHORT DURATION

(71) Applicants: Nicholas P. DE LUCA, Carmel by-the-Sea, CA (US); Andrew PERKINS, Berkeley, CA (US); William RUDWALL, Redwood City, CA (US)

(72) Inventors: Nicholas P. DE LUCA, Carmel by-the-Sea, CA (US); Andrew PERKINS, Berkeley, CA (US); William RUDWALL, Redwood City, CA (US)

(21) Appl. No.: 13/284,426

(22) Filed: Oct. 28, 2011

(51) Int. Cl. H05B 6/64; A23L 1/01

(52) U.S. Cl. 219/679; 426/243

(57) ABSTRACT

A system and process for cooking a consumable food product for an accelerated time period is described. The a system and process for cooking a food product comprising selectively heating primarily the interior of a food product, and searing the exterior of the food product using a radiative oven, wherein the radiative oven operates at greater than 900° Fahrenheit and reaches the operating temperature from an ambient temperature in a duration that is less than 30 seconds. A vending machine including the system and process of cooking is also described.

### CROSS-REFERENCE TO RELATED APPLICATIONS

U.S. Patent Application Publication No. 2010/0169196 A1 (U.S. patent application Ser. No. 12/345,899) filed Dec. 30, 2008, and U.S. Patent Application Publication No. 2010/0166397 A1 (U.S. patent application Ser. No. 12/345,939) filed Dec. 30, 2008 are incorporated herein in their entirety by reference.

### TECHNICAL FIELD

The present teachings are directed toward an improved high speed cooking system capable of thoroughly cooking and searing common foods. In particular, the disclosure relates to a high speed cooking system utilizing radiative heat along with another food cooking system to evenly and quickly cook a food product. In a preferred embodiment, the radiative heat is used with microwave ovens.

### BACKGROUND

A need has been recognized in the food industry for food cooking systems that can quickly and thoroughly heat a food product to produce a seared food product. Traditional cooking methods such as stove top, ovens, steaming, etc., take long times to cook. One method of quickly cooking food uses microwave ovens. Microwave ovens are widely used for cooking foods in a relatively short amount of time. Microwave technology provides an efficient method for cooking food by providing a resonant cavity that heats food through dielectric heating. As microwave radiation passes through the food, the polar water molecules inside the food continuously oscillate as they attempt to align themselves with the alternating electric field of the microwaves. The substance's molecular vibrations are observed as heat. This is described in great detail in U.S. Pat. No. 2,147,689 and Chemistry Society Rev., 1997. Issue 3, pages 233-238.

Although microwave ovens provide an effective system for directly heating foods and liquids such as soup, broccoli, and asparagus, they are not effective with searing and/or grilling foods such as meats, breads, or fried foods. This is primarily because the water fails to reach temperatures greater than 220° Fahrenheit (F), far below the 300° F. required to achieve grilling. Additionally, some foods do not cook evenly or well in a microwave. For example, fully cooking meats such as chicken or beef in a microwave often changes the texture and mouth feel of the meat, resulting in “rubbery” or “leathery” meat.

In some cases, foods can be delivered in a microwave with a package that has a special susceptor material that absorbs the microwave radiation and heats up beyond 220° F., providing the ability to create some charring or high temperature oil heating (as with popcorn packaging). Yet, this packaging fails to provide similar conditions to a grill or oven where high temperatures release flavors in further combination with smoke and oils. Thus, these systems cook fast, but do not produce a grilled or seared product.

Radiative heat is another way to cook food relatively quickly. For example, U.S. Application Publication No. 2010/0166397 A1 describes a cooking system that is able to cook foods in under a minute using a highly concentrated infrared radiation oven using a wire mesh. This oven operates at a power level of over 10 Kilowatts (kW) is able to cook thin food products in under a minute including pizza, bread, and bacon. The system is also very effective at very quickly heating foods such as meats, breads, vegetables, cheeses, and other starches. U.S. Application Publication No. 2010/0169196 A1 describes a similar oven that can further be combined into a vending system and is capable of delivering foods such as thin pizzas in under a minute of cooking.

Although the ovens described in U.S. Application Publications Nos. 2010/0166397 A1 and 2010/0169196 A1 are very effective as a radiation system, the infrared radiation is not effective at deeply penetrating the foods. For example, a 25 millimeter (mm) thick hamburger cooked solely using the system described in U.S. Application Publication No. 2010/0166397 A1 will only have a cooked surface at a depth of about 2-5 mm. Attempts at cycling or allowing the heat to migrate through the meat create longer than desired cycle times and thus, obviate the reasons for using the fast cooking systems. Thus, these systems cook fast, but not through thick food products.

Additionally, neither microwaves nor radiative heat systems optimize their cooking characteristics based on the intrinsic molecular make-up of the foods cooked by the system. For example, a microwave oven can heat water to 220° F. effectively, but is less effective at heating lipids quickly. Conversely, radiative ovens can heat some lipids effectively, but are less effective at heating water quickly. Additionally, radiative ovens using traditional bulb technology do not heat some lipids effectively, and the high heat causes lipids to splatter. As a result, the heated lipids land on the heating element, and actually break the bulbs.

The prior art does not, however, exemplify high speed cooking systems that produce evenly cooked, yet seared food with a satisfying taste, texture and mouth feel.

As used herein, “accelerated time” or “short duration” refers to the length of time to produce a fully cooked, seared food product by a first and/or second heat source. In some embodiments, that accelerated time refers to less than about 5 minutes. In some embodiments, the accelerated time refers to less than about 4 minutes. In some embodiments, the accelerated time refers to less than about 3 minutes, less than about 2 minutes, or less than about 1 minute.

As used herein, “food product” refers to a consumable product exposed to heat from a first and/or second heat source. The food product can be a pre-packaged product, or subjected to manufacturing processing before exposure to heat. The food product can be an un-packaged product. In some embodiments, the food product is a consumable product that includes whole fruits or vegetables. In some embodiments, the food product includes asparagus, broccoli, cauliflower, squash, zucchini, potatoes, sweet potatoes, eggplant, carrots, tomatoes, onions, or combinations thereof. In some embodiments, the food product is derived from animal protein, and includes steaks, chops, roasts or ground meat. In some embodiments, the animal protein can include beef, pork, lamb, goat, venison, buffalo, bison, chicken, turkey, pheasant, fish, shellfish, or combinations thereof. In some embodiments, the food product can be a combination of a fruit or vegetable and an animal protein. In some embodiments, the food product can be a battered food product, such as a breaded chicken cutlet, or tempura vegetables.

As used herein, “grilled,” “seared,” or “charred” refers to a caramelized crust formed on the surface of a food product as the result of exposure to high heat. In some embodiments, the crust is formed when the surface of the food exceeds 150° C. (300° F.). In some embodiments, the seared crust results in a coloration change of all or a portion of the food product. In some embodiments, the seared crust results in a changed or enhanced flavor of the food product when compared to a food product not exposed to high heat. In some embodiments, a browning, color change or flavor change can be the result of the Maillard Reaction.

When cooking food products, there are two non-enzymatic browning processes governing the release of flavors and aromas that are named Caramelization and the Maillard Reaction. However, the Maillard Reaction is the primary contributor to the flavor and aroma of cooked foods. The rate of these reactions vary, increasing with temperature and decreasing with moisture content. The Maillard Reaction is not favored in microwave cooking due to the high moisture content of the food and its surrounding air. The high moisture content of the food surface inhibits the browning effect of the Maillard Reaction, resulting in a product that is under flavored and is perceived as undercooked (See, Jennifer M. Ames, Control of the Maillard reaction in food systems, Trends in Food Science & Technology, Volume 1, July 1990, Pages 150-154).

Pyrolyisis is the process that is specifically responsible for the browning at the outermost layer of a cooked food product. Pyrolysis of carbohydrates and proteins requires temperatures substantially higher than 100° C. (212° F.), so pyrolysis does not occur as long as free water is present, e.g., in boiling food—not even in a pressure cooker. When heated in the presence of water, carbohydrates and proteins suffer gradual hydrolysis rather than pyrolysis. Indeed, for most foods, pyrolysis is usually confined to the outer layers of food, and begins only after those layers have dried out.

### SUMMARY

According to one embodiment, a method of cooking a food product comprising providing a radiative oven comprising a heating element and a stored energy element to power the heating element, selectively heating primarily an interior of a food product, and searing an exterior of the food product using the radiative oven is described.

In some embodiments, the heating element operates at greater than 800° Fahrenheit and reaches the operating temperature from an ambient temperature in a duration that is less than 30 seconds. In some embodiments, the radiative oven operates at greater than 1100° Fahrenheit and reaches the operating temperature from an ambient temperature in a duration that is less than 5 seconds.

In some embodiments, the method further comprises providing a vending machine including the radiative oven, dispensing the food product into the radiative oven, and dispensing to the consumer. In some embodiments, the vending machine further comprises a microwave oven for the selectively heating of primarily the interior of the food product. In some embodiments, the method further comprises packaging the food product in a plastic pouch prior to cooking. In some embodiments, the dispensing of the food product into the radiative oven is by a user. In some embodiments, the dispensing of the food product into the radiative oven is by an automated dispenser. In some embodiments, the method further comprises removing the food product from a pouch prior to dispensing the food product into the radiative oven.

In some embodiments, the method further comprises dispensing bread in the radiative oven along with the food product. In some embodiments, the searing comprises heating an exterior of the food product to char an exterior surface of the food product. In some embodiments, the selectively heating partially cooks the food product. In some embodiments, the method further comprises breading the food product after the selectively heating of the food product. In some embodiments, the selectively heating of the food product is done at a food preparation center and the searing is done at a location remote to the food preparation center.

In some embodiments, the food product is a ground hamburger patty, a salmon filet, a chicken filet, a French fry, or a vegetable. In some embodiments, the food product is a ground hamburger patty, a microwave oven selectively heats primarily the interior of the ground hamburger patty for 60 seconds; and a radiative oven sears the exterior portion of the hamburger patty for 60 seconds. In some embodiment, the food product is a salmon fillet, a microwave oven selectively heats primarily the interior of the salmon filet for 40 seconds; and a radiative oven sears the exterior portion of the salmon filet for 45 seconds. In some embodiments, the food product is a chicken breast, a microwave oven selectively heats primarily the interior of the chicken breast for 140 seconds; and a radiative oven sears the exterior portion of the chicken breast for 80 seconds. In some embodiments, the food product is an asparagus spear, a microwave oven selectively heats primarily the interior of the asparagus spear for 40 seconds; and a radiative oven sears the exterior portion of the asparagus spear for 12 seconds.

In some embodiments, the heating element comprises a wire mesh element. In some embodiments, the heating element comprises a lamp.

### BRIEF DESCRIPTION OF THE DRAWINGS

The same reference number represents the same element on all drawings. It should be noted that the drawings are not necessarily to scale. The foregoing and other objects, aspects, and advantages are better understood from the following detailed description of a preferred embodiment of the invention with reference to the drawings, in which:

FIG. 1 illustrates a high speed radiative oven used in combination with a microwave oven according to one embodiment;

FIG. 2 shows the combined ovens of FIG. 1 in conjunction with a vending system;

FIG. 3 is a photograph of a hamburger cooked with the system and process according to one embodiment;

FIG. 4 is a photograph of asparagus cooked with the system and process according to one embodiment;

FIG. 5 is a photograph of a chicken breast cooked with the system and process according to one embodiment; and

FIG. 6 is photograph of a salmon filet cooked with the system and process according to one embodiment.

FIG. 7 is a photograph of a hamburger cooked using a radiative oven only.

FIG. 8 is a photograph of a hamburger cooked using a microwave oven only.

FIG. 9 is a photograph of a hamburger cooked with the system and process according to one embodiment.

### DETAILED DESCRIPTION

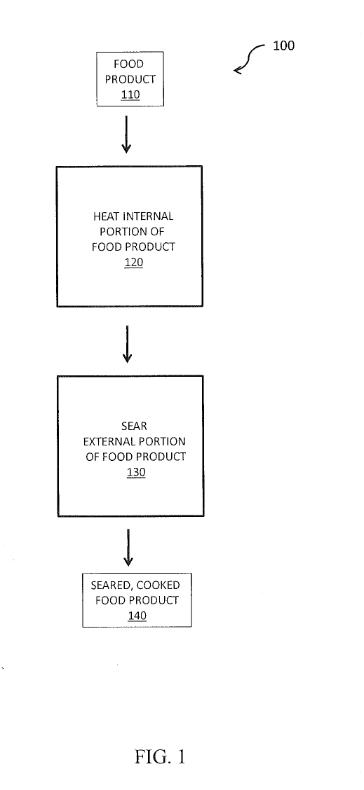

FIGS. 1-6 and the following descriptions depict specific embodiments to teach those skilled in the art how to make and use the best mode of the teachings. For the purpose of teaching these principles, some conventional aspects have been simplified or omitted. Those skilled in the art will appreciate variations from these embodiments that fall within the scope of the teachings. Those skilled in the art will also appreciate that the features described below can be combined in various ways to form multiple variations. As a result, the teachings are not limited to the specific embodiments described below, but only by the claims and their equivalents.

In some embodiments, a system and process for cooking a food product comprising selectively heating primarily the interior of a food product, and searing the exterior of the food product using a radiative oven, wherein the radiative oven operates at greater than 1100° Fahrenheit and reaches the operating temperature from an ambient temperature in a duration that is less than 5 seconds is described.

As shown in FIG. 1, a food product 110 is heated according to the system and method 100 described herein. Specifically, an interior portion of food product 120 is heated to heat primarily (or selectively) an interior portion of food product 110. The time and temperature that the interior portion of food product 120 is heated will vary depending upon the type of food product 110 and the heat source. Non-limiting examples of heat sources to heat the interior portion of food product 120 include microwave ovens, steam baths, or other sources of conduction. In some examples, the heat source requires direct contact with food product 110. In some examples, the heat source requires indirect contact with food product 110. In one example, food product 110 is placed within a microwave oven and heated via microwaves.

Once the interior portion of food product 120 is sufficiently heated, the partially heated food product 120 is transferred to a second heat source where the exterior portion of food product 120 is seared 130. The time and temperature that the exterior portion of food product 120 is seared will vary depending upon the type of food product 110 and the heat source. Non-limiting examples of sources to sear the exterior portion of food product 120 include radiation ovens, grills, broilers, etc. In some examples, the searing heat source requires direct contact with food product 120. In some examples, the searing heat source requires indirect contact with food product 120. In one example, food product 120 is placed within a 10 kW (or more) radiative oven and heated via radiation.

Importantly, the ability to sear the exterior portion of food product 120 must occur quickly. Thus, a source of heat to sear or char food product 120 must be able to reach charring temperature from ambient temperature in short duration. In some embodiments, the source of heat can reach about 900° F., about 1000° F., about 1100° or about 1200° F. in less than about 30 seconds. In some embodiments the source of heat can reach about 900° F., about 1000° F., 1100° or about 1200° F. in less than about 20 seconds. In some embodiments, the source of heat can reach about 900° F., about 1000° F., 1100° or about 1200° F. in less than about 10 seconds from ambient temperature. In some embodiments, the source of heat can reach about 900° F., about 1000° F., 1100° or about 1200° F. in less than about 5 seconds from ambient temperature.

The exterior portion of food product 120 must occur quickly, or in short duration without burning food product 120, and allowing the interior portion of food product 120 to finish cooking. In some embodiments, the charring of exterior portion of food product 120 must occur in less than 120 seconds. In some embodiments, the charring of the exterior portion of food product 120 must occur in less than about 110, about 100, about 90, about 80, about 70, about 60, about 50, about 40, about 30, about 20, about 10 or about 5 seconds, or any interval therebetween.

In some embodiments, the charring of the exterior portion of food product 120 can occur from a single exposure to a searing heat source. In some embodiments, the charring of the exterior portion of food product 120 can occur from multiple exposures to a searing heat source. For example, food product 120 that has already had an interior portion partially heated can be exposed to a searing heat source for 20 seconds, when the searing heat source sears both a top portion and a bottom portion of food product 120 concurrently. In another example, food product 120 that has already had an interior portion partially heated can be exposed to a searing heat source for a total of 30 seconds, with a first exposure of 15 seconds to a top portion of food product 120, and a second exposure of 15 seconds to a bottom portion of food product 120. Of course, other protocols for exposing food product 120 that has already had an interior portion partially heated are contemplated.

In a preferred embodiment, food product 110 is heated using a microwave oven until the interior portion of food product 120 is sufficiently heated. Food product 120 is then transferred to a 13-14 kW (or more) radiative oven capable of reaching about 1100° F. in less than 5 seconds from an ambient temperature. The external portion of food product 120 is then exposed to radiant heat from the 13-14 kW (or more) radiative oven for a time sufficient to sear the external portion of food product 120.

The process of heating primarily an interior portion of food product 120 and searing an exterior portion of food product 130 advantageously not only cooks and sears food very quickly, but produces a fully cooked seared food product 140 with superior taste, consistency and mouth feel when compared to traditional cooking processes which take much longer to produce. In part, such results are due to considerations such as molecular make-up, thickness, and solidity of the food product.

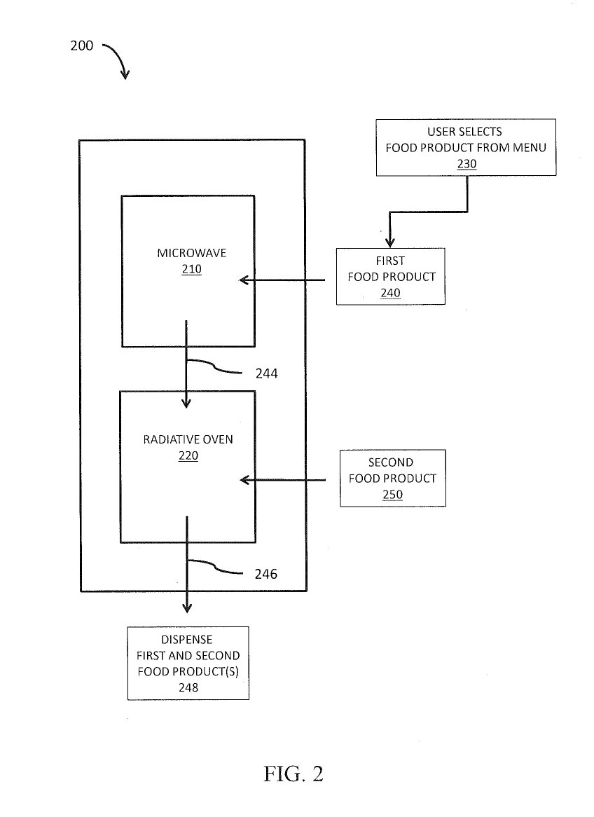

FIG. 2 illustrates one example of the process described herein when incorporated into a vending machine 200. In one example, a user selects food product 240 from a menu or display. A first food product 240 is then transferred to a heat source (e.g., a microwave 210) which selectively partially cooks an interior portion of first food product 240 for a predetermined time (step 210). Once the predetermined time has elapsed, first food product 240 is transferred to a second heat source (e.g., a 10 kW (or more) radiative oven), where the exterior portion of food product 240 is seared as the interior portion of food product continues to finish cooking (step 220). Once seared, food product is dispensed to a user 248. In some embodiments, a second food product 250, such as a bun for a burger or hotdog, can also be heated along with first food product 240. In this instance, second food product 250 can be exposed to a radiative oven 220 briefly to warm and toast the food product 250. In such instances, second food product 250 can be dispensed with first food product 240 to a user at step 248. In some instances, second food product 250 can be dispensed before first food product 240 is dispensed to a user at step 248. In some instances, second food product 250 can be dispensed after first food product 240 is dispensed to a user at step 248.

In some embodiments of vending machine 200, both a microwave and a radiative oven can be housed in the same machine. In some embodiments, vending machine 200 may only house a radiative oven, and the heat source which heats primarily the interior portion of food product 240 is located nearby. For example, the vending machine may house the radiative oven, but the microwave may be across a room, or located in another room in a commercial setting. In an example where vending machine 200 houses both a microwave oven and a 10 kW, 11 kW, 12, kW, 13 kW or 14 kW oven, these heat sources may share a single power source such as energy from a standard 110 V wall outlet. In some embodiments where vending machine 200 houses both a microwave oven and a 10 kW, 11 kW, 12, kW, 13 kW or 14 kW radiative oven, these heat sources may have different power sources. For example, the microwave oven may include a standard plug for a 110 Volt outlet, and the microwave oven may be powered by a stored energy device.

In some embodiments, a food product can be distributed as a fully cooked, but refrigerated or frozen product that required heating. Such packaging would allow the food product to have an adequate shelf life to not degrade or spoil until ready to be consumed. In some embodiments, the food product can be distributed as wholly uncooked products, and will be fully cooked by exposure to the first and second heat sources.

Food product may contain a single food product, or may contain several distinct portions. For example, the food product may be a single chicken breast. In another example, the food product may be a hamburger patty, French fries and hamburger bun. In some examples, the food product is purchased by the end user separately for use of the cooking system. In some embodiments, the food product is purchased with use of the cooking system at the time of cooking.

In embodiments wherein the food product is purchased at the time the system is used to cook the food product, the packaging may individually package each food item. In other embodiments, a food product made of multiple components may be packaged together.

As discussed above, the present process optimizes the heating of the food product based on the intrinsic molecular make-up of the foods cooked by the system. Foods have different heat permeability characteristics depending upon type, density, size, and weight. For example, a 1″×1″×1″ beef steak has a lower heat permeability than a 1″×1″×1″ cubed potato, which has a lower heat permeability to 1″×1″×1″ hamburger patty of ground beef. A skilled artisan would readily understand how to adjust the cooking parameters in order to cook partially the interior portion of the food product only enough to allow the exterior portion to be seared sufficiently while allowing the interior portion to finish cooking. Thus, a skilled artisan would be able to adjust the cooking parameter to sear a 1″ thick beef steak to a rare, medium rare, medium or well interior temperature.

For example, a skilled artisan would know how to adjust cooking beef or lamb to the following internal temperatures shown in Table 1:

| | | |
|---|---|---|
| Rare | 120 to 125 | center is bright red, pinkish toward |
| | degrees F. | the exterior portion |
| Medium Rare | 130 to 135 | center is very pink, slightly brown |
| | degrees F. | toward the exterior portion |
| Medium | 140 to 145 | center is light pink, outer portion |
| | degrees F. | is brown |
| Medium Well | 150 to 155 | not pink |
| | degrees F. | |
| Well Done | 160 degrees F. | meat is uniformly brown throughout |
| | and above | |

### Example 1

A study of the heating and absorption characteristics of water and various lipids was performed using a microwave oven or a 14-15 kW radiative oven was performed. In a first study, the time for 50 grams (g) of water or 100% olive oil to reach 200 degrees was measured. In a second study, the time for 75 grams of water or 100% olive oil to reach 300 degrees was measured. A Panasonic brand microwave model SD997 operating at 1250 W was used in the microwave portion of the study. A radiative oven operating at about 14-15K watts, similar to those described in U.S. Application Publications Nos. 2010/0166397 A1 and 2010/0169196 A1 was used in the radiative portion of the study. The results of the study are presented in Table 2:

TABLE 2

| | Time for 50 g of food | Time for 75 g of food |
|---|---|---|
| Food/Heat Source | product to reach 200° F. | product to reach 300° F. |
| Water/Microwave | 25 seconds | Not feasible (max temp |
| | | reached: 212° F.) |
| Water/15 kW Oven | 50 seconds | Not feasible (max temp |
| | | reached: 212° F.) |
| 100% Olive Oil/ | 45 seconds | 110 seconds |
| Microwave | | |
| 100% Olive Oil/ | 8 seconds | 25 seconds |
| 15 kW Oven | | |

As seen from the table, the microwave is able to raise the temperature of the water, but is not as effective with respect to raising the temperature of the olive oil. In fact, the maximum temperature of the water reached was 212° F. degrees. Searing of food occurs at 300° F. As such, a microwave oven cannot easily produce charred food. In contrast, the high radiation oven is able to raise the temperature of the fat and water, but is not able to do so as effectively for the water as a microwave.

### Example 2

The optimized accelerated cooking protocols of various food products were performed using a microwave oven and a 14-15 kW radiative oven. Specifically, asparagus, french fries (raw and frozen), chicken breast, salmon filets or hamburger patties were cooked using microwaves and a radiative oven. A Panasonic brand microwave model SD997 operating at 1250 W was used in the microwave portion of the study. A radiative oven operating at 14-15 kW watts, similar to those described in U.S. Application Publications Nos. 2010/0166397 A1 and 2010/0169196 A1 was used. The specific cooking times and protocols are presented in Table 3:

TABLE 2

| FOOD | MICROWAVE TIME | OVEN TIME |
|---|---|---|
| Asparagus | 40 seconds (wrapped in | 12 seconds |
| (6 pieces - avg. | a damp paper towel) | (top and bottom) |
| diameter = 0.39 inch) | | |
| French fries - raw | 50 seconds | 20 seconds |
| (6 pieces - avg. | | (top and bottom) |
| thickness = 0.33 inch) | | |
| French fries - frozen | 60 seconds | 15 seconds |
| (6 pieces - avg. | | (top and bottom) |
| thickness = 0.38 inch) | | |
| 7 oz. Chicken Breast | 70 seconds | 50 seconds |
| (max. thickness range: | Flip chicken breast | (top and bottom) |
| 1.2-1.7 inches) | 70 seconds (inside | 20 seconds |
| | microwave safe bowl and | (bottom only) |
| | covered in plastic wrap) | 10 seconds |
| | | (top and bottom) |
| 7 oz. Salmon Filet | 40 seconds (inside | 35 seconds |
| (1.25 inch thick) | microwave safe bowl and | (top and bottom) |
| | covered in plastic wrap) | 10 seconds |
| | | (bottom only) |
| 6 oz hamburger patty | 60 seconds | 60 seconds |
| | | (top and bottom) |

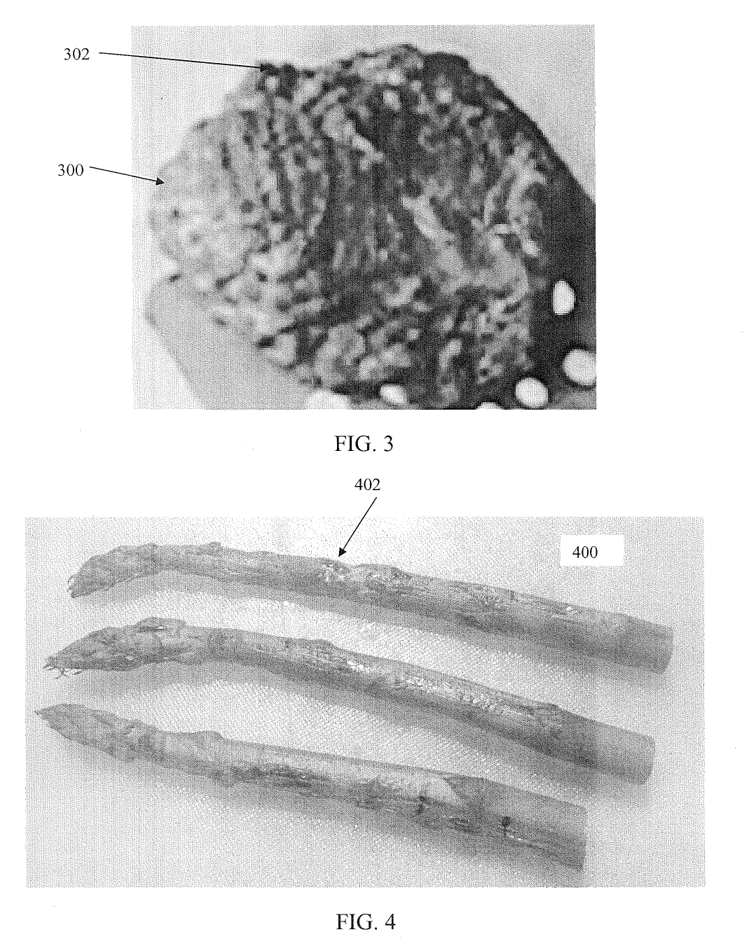

As seen from the table and FIGS. 3-6, exposure of the food product to microwaves and then to radiative heat is able to cook thoroughly the various foods while producing an adequate seared crust. FIG. 3 illustrates a 6 oz. ground beef hamburger patty 300 that has had an interior portion partially cooked using a microwave oven at high power for 60 seconds. The hamburger patty 300 was then transferred to a 14 kW high-speed radiative oven and exposed to radiative heat for 60 seconds, using top and bottom radiative wire mesh burners concurrently. As a result, sear marks 302 can be viewed on a significant portion of the exterior portion of the hamburger patty 300.

FIG. 4 illustrates 6 asparagus spears 400 that have had an interior portion partially cooked using a microwave oven at high power for 40 seconds wrapped in a wet paper towel. The asparagus spears 400 was then transferred to a 14 kW oven and exposed to radiative heat for 12 seconds, using top and bottom radiative wire mesh burners concurrently. As a result, sear marks 402 can be viewed on a significant portion of the exterior portion of the asparagus spears 400.

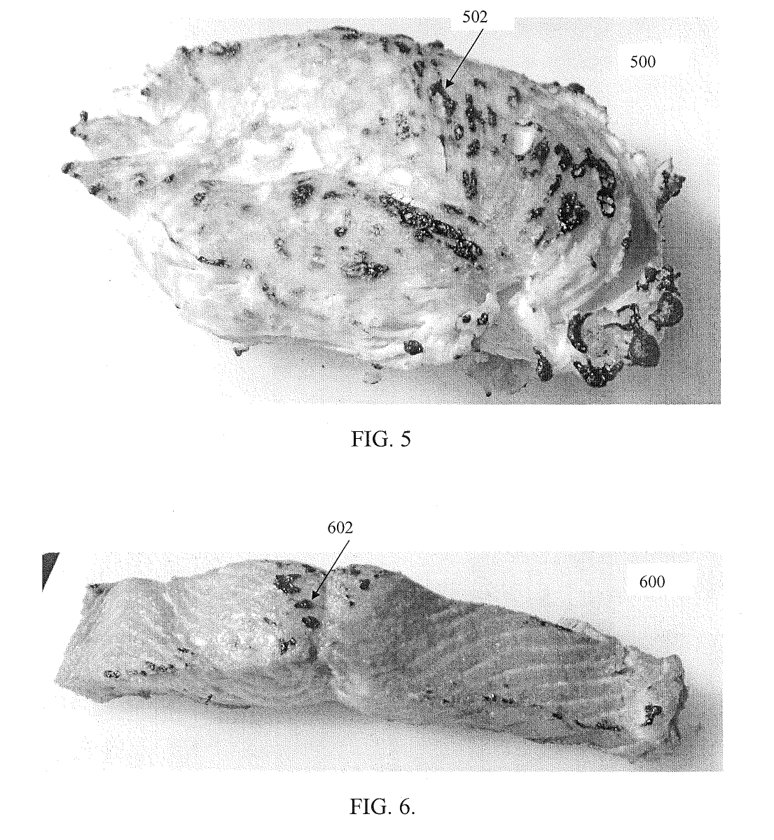

FIG. 5 illustrates chicken breast 500 that has had an interior portion partially cooked using a microwave oven at high power for 70 seconds, then the chicken breast was flipped, and microwaved again for 70 seconds. The chicken was cooked inside a microwave safe bowl and covered in plastic wrap. The chicken breast 500 was then transferred to a 14 kW oven and exposed to radiative heat for 50 seconds using top and bottom wire mesh burners concurrently. The chicken breast was then exposed to radiative heat for an additional 20 seconds using bottom wire mesh burners only. Finally, the chicken breast was exposed to radiative heat for 10 seconds using both top and bottom wire mesh burners concurrently. As a result, sear marks 502 can be viewed on a significant portion of the exterior portion of the chicken breast 500.

FIG. 6 illustrates salmon filet 600 that has had an interior portion partially cooked using a microwave oven at high power for 40 seconds inside a microwave safe bowl and covered in plastic wrap. The salmon filet 600 was then transferred to a 14-15 kW oven and exposed to radiative heat for 35 seconds using top and bottom wire mesh burners concurrently. The salmon filet 600 was then exposed to radiative heat for an additional 10 seconds using a bottom wire mesh burners only. As a result, sear marks 602 can be viewed on a significant portion of the exterior portion of the chicken breast 600.

### Example 3

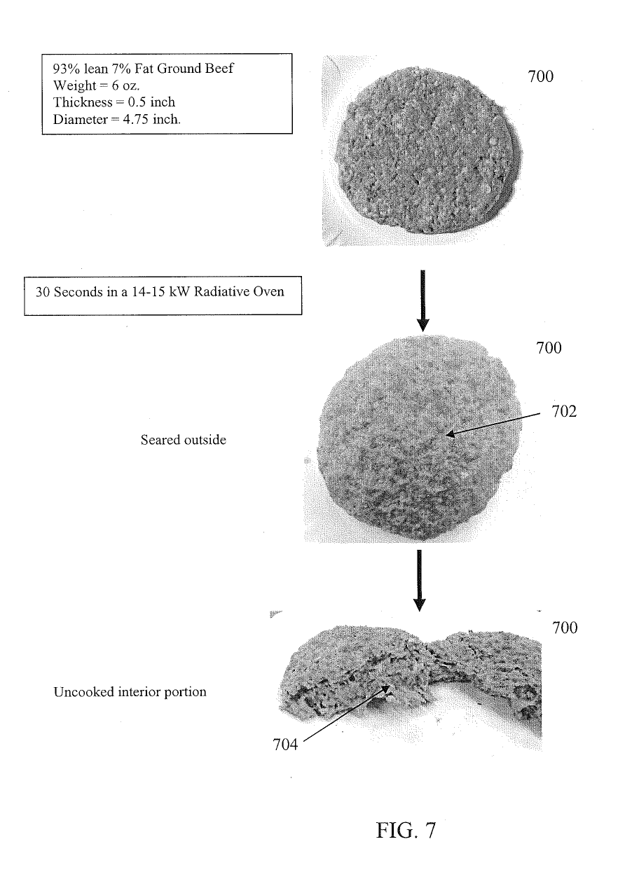

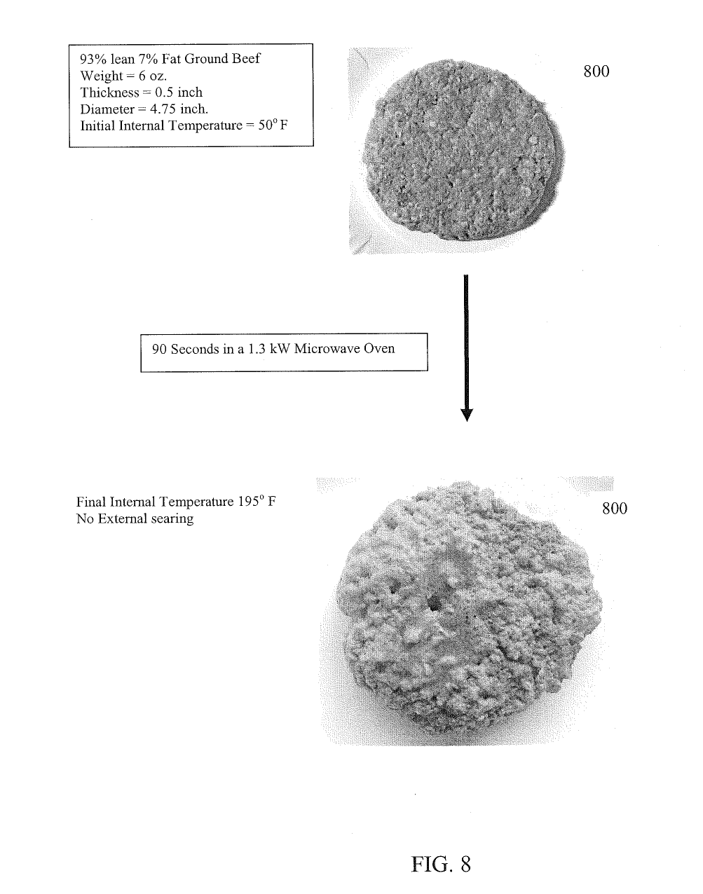

FIG. 7 illustrates a 6 oz. that has had an exterior seared using a 14-15 kW radiative oven for 30 seconds. The hamburger patty 700 comprised about 93% lean ground beef, about 7% beef fat in a hamburger patty 700 of about 0.5 inches in thickness, and a diameter of about 4.75 inches. Hamburger patty 700 showed distinctive sear marks 702 on the exterior portion of the patty. However, an interior portion of the patty 704 reveal uncooked raw beef. Thus, cooking a hamburger patty for short durations with a high power radiative oven is insufficient to cook both in interior portion and a seared exterior portion of a hamburger patty 700.

### Example 4

FIG. 8 illustrates a 6 oz. that has had an interior portion cooked using a 1.3 kW microwave oven for 90 seconds. The hamburger patty 800 comprised about 93% lean ground beef, about 7% beef fat in a patty of about 0.5 inches in thickness, and a diameter of about 4.75 inches. Hamburger patty 800 had a final internal temperature of about 195° F. (relating to well done beef) and showed no external sear marks on patty 800. Thus, cooking a hamburger patty for short durations with a microwave oven is insufficient to cook both in interior portion and a seared exterior portion of a hamburger patty 800.

### Example 5

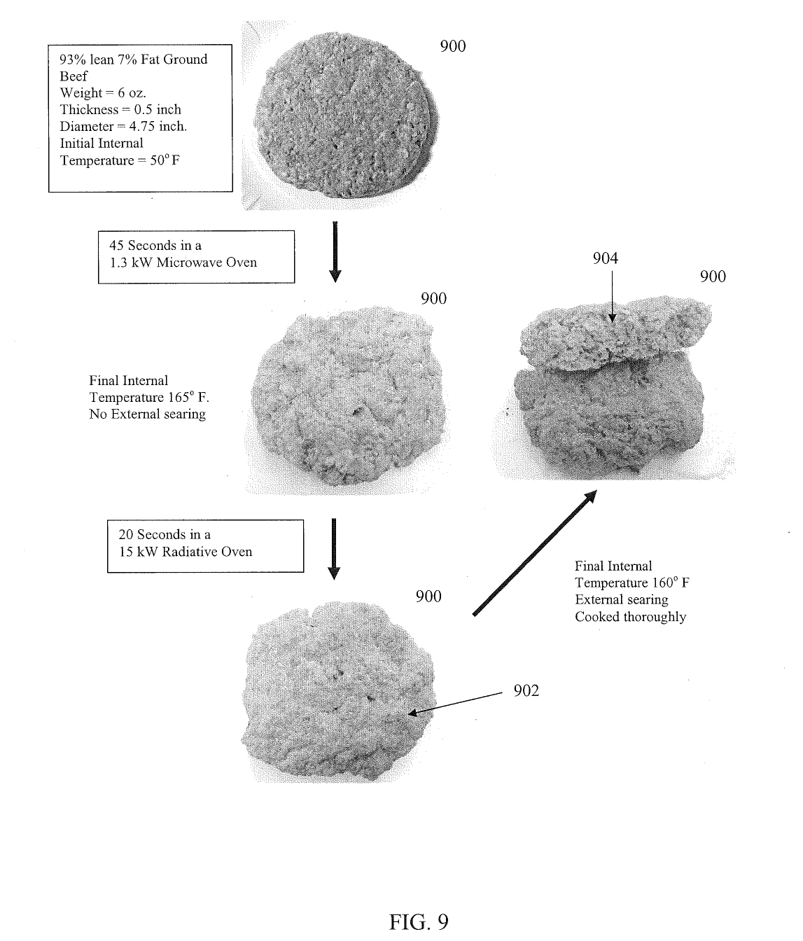

FIG. 9 illustrates a 6 oz. that has had an interior portion cooked using a 1.3 kW microwave oven for 45 seconds, and the hamburger patty was immediately transferred to a 14-15 kW radiative oven and cooked for an additional 20 seconds. The hamburger patty 900 comprised about 93% lean ground beef, about 7% beef fat in a patty about 0.5 inches in thickness, and a diameter of about 4.75 inches. Hamburger patty 900 had a final internal temperature of 165° F. after microwaving (relating to well done beef) but showed no external sear marks on patty 900. After transfer to the 14-15 kW radiative oven and cooked for 20 seconds, hamburger patty 900 had an internal temperature of 160° F., external sear marks 902, and was thoroughly cooked. Thus, cooking a hamburger patty for short durations with a microwave oven and a high powered radiative oven is sufficient to cook both in interior portion and a seared exterior portion of a hamburger patty 900.

These examples demonstrate the versatility of the system described herein, cooking fresh and frozen food products, as well as both ground beef patties and solid animal protein food products such as chicken breasts and salmon filets. The process can be implemented according to any of the embodiments in order to obtain several advantages, if desired. An effective and fast process of searing a food product with superior taste, texture and mouth feel can be provided. Advantageously, the food product is produced faster and with higher quality than with any process currently available.

The various embodiments described above are provided by way of illustration only and should not be construed to limit the invention. Those skilled in the art will readily recognize the various modifications and changes which may be made to the present invention without strictly following the exemplary embodiments illustrated and described herein, and without departing from the true spirit and scope of the present invention, which are set forth in the following claims.

What is claimed is:

1. A method of cooking a food product comprising:
providing a radiative oven comprising a heating element and a stored energy element to power the heating element;
selectively heating primarily an interior of a food product; and
searing an exterior of the food product using the radiative oven.

2. The method of claim 1, wherein the heating element operates at greater than 800° Fahrenheit and reaches the operating temperature from an ambient temperature in a duration that is less than 30 seconds.

3. The method of claim 1, wherein the radiative oven operates at greater than 1100° Fahrenheit and reaches the operating temperature from an ambient temperature in a duration that is less than 5 seconds.

4. The method of claim 1, further comprising:
providing a vending machine including the radiative oven;
dispensing the food product into the radiative oven; and
dispensing to the consumer.

5. The method of claim 4, wherein the vending machine further comprises a microwave oven for the selectively heating of primarily the interior of the food product.

6. The method of claim 4, further comprising packaging the food product in a plastic pouch prior to cooking.

7. The method of claim 4, wherein the dispensing of the food product into the radiative oven is by a user.

8. The method of claim 4, wherein the dispensing of the food product into the radiative oven is by an automated dispenser.

9. The method of claim 4, further comprising removing the food product from a pouch prior to dispensing the food product into the radiative oven.

10. The method of claim 4, further comprising dispensing bread in the radiative oven along with the food product.

11. The method of claim 1, wherein the searing comprises heating an exterior of the food product to char an exterior surface of the food product.

12. The method of claim 1, wherein the selectively heating partially cooks the food product.

13. The method of claim 1, further comprising breading the food product after the selectively heating of the food product.

14. The method of claim 1, wherein the selectively heating of the food product is done at a food preparation center and the searing is done at a location remote to the food preparation center.

15. The method of claim 1, wherein the food product is a ground hamburger patty, a salmon filet, a chicken filet, a French fry, or a vegetable.

16. The method of claim 15, wherein the food product is a ground hamburger patty, a microwave oven selectively heats primarily the interior of the ground hamburger patty for 60 seconds; and
a radiative oven sears the exterior portion of the hamburger patty for 60 seconds.

17. The method of claim 15, wherein the food product is a salmon fillet, a microwave oven selectively heats primarily the interior of the salmon filet for 40 seconds; and
a radiative oven sears the exterior portion of the salmon filet for 45 seconds.

18. The method of claim 15, wherein the food product is a chicken breast, a microwave oven selectively heats primarily the interior of the chicken breast for 140 seconds; and
a radiative oven sears the exterior portion of the chicken breast for 80 seconds.

19. The method of claim 15, wherein the food product is an asparagus spear, a microwave oven selectively heats primarily the interior of the asparagus spear for 40 seconds; and
a radiative oven sears the exterior portion of the asparagus spear for 12 seconds.

20. The method of claim 1, wherein the heating element comprises a wire mesh element.

21. The method of claim 1, wherein the heating element comprises a lamp.
